(19) United States
(12) Patent Application Publication
(10) Pub. No.: US 2025/0027658 A1
(43) Pub. Date: Jan. 23, 2025

(54) ELECTRIC RANGE

(71) Applicant: LG ELECTRONICS INC., Seoul (KR)

(72) Inventors: Seunghak KIM, Seoul (KR); Junghyeon Cho, Seoul (KR); Jaeho Lee, Seoul (KR)

(21) Appl. No.: 18/906,609

(22) Filed: Oct. 4, 2024

Related U.S. Application Data
(62) Division of application No. 17/189,690, filed on Mar. 2, 2021.

(30) Foreign Application Priority Data
Mar. 12, 2020 (KR) 10-2020-0030921

(51) Int. Cl. F24C 15/10

(52) U.S. Cl. CPC F24C 15/107; F24C 15/102

(57) ABSTRACT

An electric range is provided that employs a plurality of base plates to prevent sagging of the plurality of base plates. In the electric range, at least one end of each of the plurality of base plates is bent to prevent sagging of the base plate.

### CROSS-REFERENCE TO RELATED APPLICATIONS

This application is a Divisional Application of prior U.S. patent application Ser. No. 17/189,690 filed Mar. 2, 2021, which claims priority under 35 U.S.C. § 119 to Korean Application No. 10-2020-0030921, filed in Korea on Mar. 12, 2020, whose entire disclosures are hereby incorporated by reference.

### BACKGROUND

### 1. Field

An electric range is disclosed herein.

### 2. Background

Various types of cooking appliances are used to heat food or other items (hereinafter, collectively “food”) at homes or restaurants. The cooking appliances include gas ranges using gas and electric ranges using electricity.

The electric ranges are classified as resistance heating-type electric ranges and induction heating-type electric ranges. In a resistance heating method, electric current is supplied to a metallic resistance wire or a non-metallic heat generation element, such as silicon carbide, to generate heat, and the generated heat is radiated or conducted to heat an object to be heated, for example, a cooking vessel, such as a pot, or a frying pan, for example. In an induction heating method, high-frequency power is supplied to a coil to generate a magnetic field around the coil, and eddy current produced in the generated magnetic field is used to heat an object to be heated made of a metallic material.

Regarding basic theories of induction heating, when electric current is supplied to a working coil or a heating coil, heat is generated while an object to be heated is inductively heated, and the object to be heated is heated by the generated heat.

FIGS. 1A-1B are views showing a shape of a related art induction heating device disclosed in European Patent No. 2 765 827, which is hereby incorporated by reference. Referring to FIG. 1, in the related art, a support portion, formed by bending of a portion of a lateral wall 30 of a housing, supports a single shield plate 22. A plurality of heating units (heating coils) 20 is disposed on the single shield plate 22.

In this case, the shield plate 22 sags due to a weight of the plurality of heating units 20 because the plurality of heating units 20 is supported by the single shield plate 22. However, the related art provides no solution to the problem of sagging of the shield plate 22.

Additionally, in a large-sized related art induction heating device, a single dual heating coil and a plurality of single heating coils are disposed on a single base plate. The dual heating coil is disposed at a center of the base plate, and the plurality of single heating coils is disposed on left and right sides of the dual heating coil. In the large-sized induction heating device of the related art, the base plate has a higher tendency to sag downward.

### BRIEF DESCRIPTION OF THE DRAWINGS

Embodiments will be described in detail with reference to the following drawings in which like reference numerals refer to like elements, and wherein:

FIGS. 1A-1B are views of a related art electric range;

FIG. 2 is a perspective view showing an induction heating device according to an embodiment;

FIGS. 3 to 6 are perspective views showing the induction heating device in FIG. 2 without some components;

FIG. 7 is a perspective view showing a first base plate according to an embodiment;

FIG. 8 is a perspective view showing a second base plate and a third base plate according to an embodiment;

FIG. 9 is a cross-sectional view showing a base plate disposed in a case, according to an embodiment;

FIGS. 10A-10B are perspective views showing a bracket according to an embodiment;

FIG. 11 is a perspective view showing a case in which a base plate according to another embodiment is disposed;

FIG. 12 is a perspective view showing a case in which a reinforcement beam is disposed, according to the another embodiment;

FIG. 13 is a perspective view showing a first base plate according to the another embodiment;

FIG. 14 is a perspective view showing a second base plate and a third base plate according to the another embodiment; and

FIG. 15 is a cross-sectional view showing a base plate disposed in a case, according to the another embodiment.

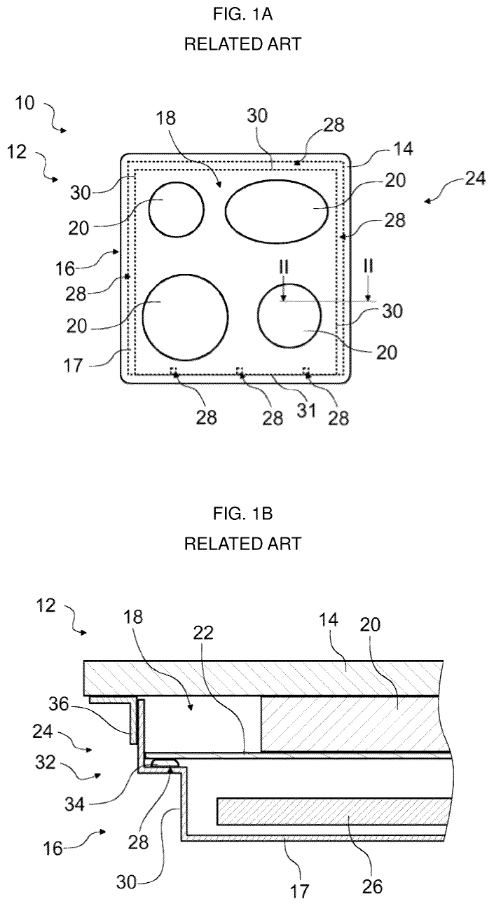

### DETAILED DESCRIPTION

Embodiments are described hereinafter with reference to the accompanying drawings such that one having ordinary skill in the art to which embodiments pertain may easily implement the technical idea. In the disclosure, description of known technologies in relation to the disclosure is omitted if it is deemed to make the gist unnecessarily vague. Hereinafter, embodiments are specifically described with reference to the accompanying drawings. In the drawings, identical reference numerals can denote identical or similar components.

The terms “first”, “second” and the like are used herein only to distinguish one component from another component. Thus, the components should not be limited by the terms. Certainly, a first component can be a second component unless stated to the contrary.

When one component is described as being “in an upper portion (or a lower portion)” of another component, or “on (or under)” another component, one component can be placed on the upper surface (or under the lower surface) of another component, and an additional component can be interposed between another component and one component on (or under) another component.

When one component is described as being “connected”, “coupled”, or “connected” to another component, one component can be directly connected, coupled or connected to another component; however, it is also to be understood that an additional component can be “interposed” between the two components, or the two components can be “connected”, “coupled”, or “connected” through an additional component.

Hereinafter, each component may be provided as a single one or a plurality of ones, unless explicitly stated to the contrary.

The singular forms “a”, “an” and “the” are intended to include the plural forms as well, unless explicitly indicated otherwise. It should be further understood that the terms “comprise” or “have,” set forth herein, are not interpreted as necessarily including all the stated components or steps but can be interpreted as including some of the stated components or steps or can be interpreted as further including additional components or steps.

Hereinafter, the terms “A and/or B” as used herein can denote A, B or A and B, and the terms “C to D” can denote C or greater and D or less, unless stated to the contrary.

Hereinafter, an electric range is described with reference to embodiments. The electric range disclosed herein may include an electric resistance-type electric range and an induction heating-type electric range, for example, an induction heating device. For convenience, an induction heating device, provided with a working coil as a heating unit, is described as an example during description of the embodiments. However, embodiments are not limited to those set forth herein.

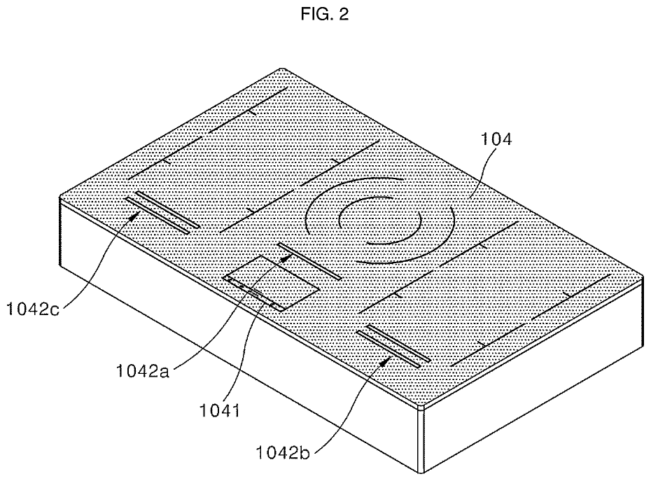

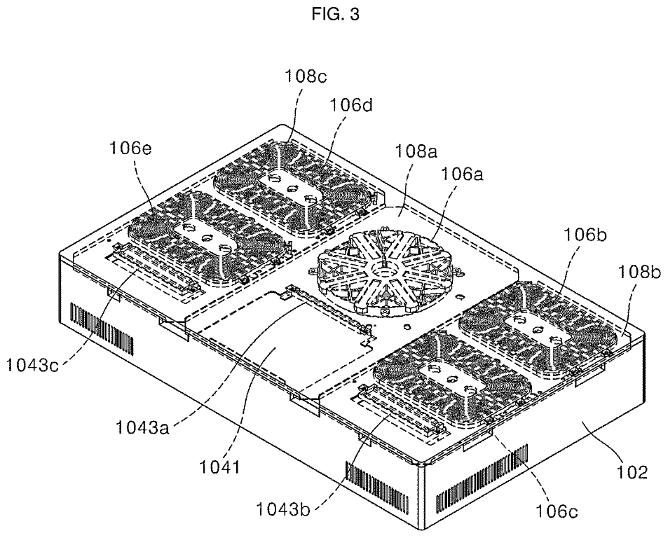

FIG. 2 is a perspective view showing an induction heating device 100 according to an embodiment. FIGS. 3 to 6 are perspective views showing the induction heating device 100 in FIG. 2 without some components.

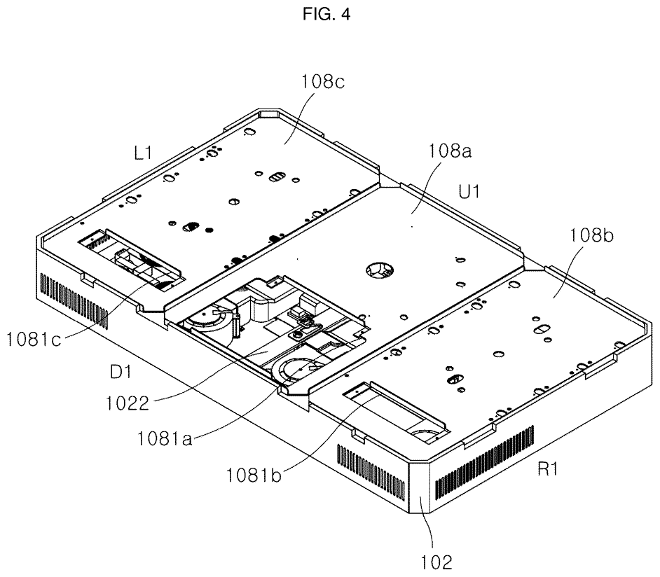

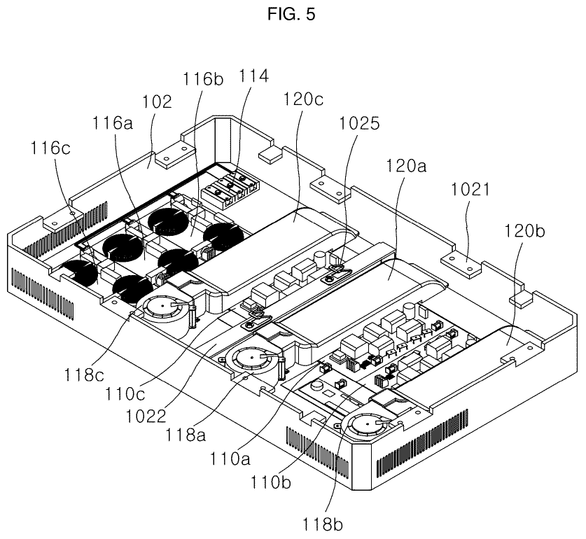

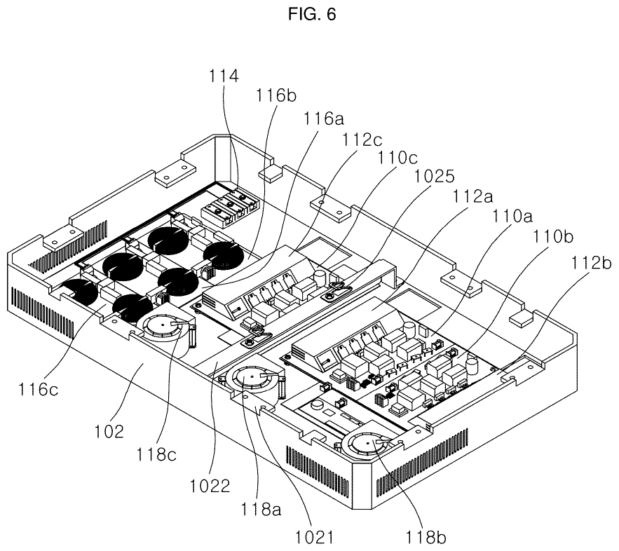

More specifically, FIG. 3 is a view showing the induction heating device 100 in FIG. 2 without a cover plate 104. FIG. 4 is a view showing the induction heating device 100 in FIG. 2 without cover plate 104 and working coils 106a, 106b, 106c, 106d, 106e. FIG. 5 is a view showing the induction heating device 100 in FIG. 2 without cover plate 104, working coils 106a, 106b, 106c, 106d, 106e, and base plate 108a, 108b, 108c. FIG. 6 is a view showing the induction heating device 100 in FIG. 2 without cover plate 104, working coil 106a, 106b, 106c, 106d, 106e, base plate 108a, 108b, 108c, and air guide 120a, 120b, 120c.

Referring to FIGS. 2 to 6, the induction heating device 100 according to an embodiment may include a case 102, cover plate 104, working coils 106a, 106b, 106c, 106d, 106e, base plate 108a, 108b, 108c, a drive circuit 110a, 110b, 110c, a heat sink 112a, 112b, 112c, a power feeder 114, a filter circuit 116a, 116b, 116c, an air blowing fan (fan) 118a, 118b, 118c, and an air guide 120a, 120b, 120c. The case 102 may protect components in the induction heating device 100. For example, the case 102 may be made of aluminum; however, embodiments are not limited thereto. The case 102 may be thermally insulated to prevent heat, generated by the working coil 106a, 106b, 106c, 106d, 106e, from leaking outward.

The cover plate 104 may be coupled to an upper end of the case 102 to shield an inside of the case 102, and an object to be heated (not illustrated, an object to be heated by one or more working coils 106a, 106b, 106c, 106d, 106e) may be placed on an upper surface of the cover plate 104.

An object to be heated, such as a cooking vessel, may be placed on the upper surface of the cover plate 104, and heat generated by the working coil 106a, 106b, 106c, 106d, 106e may be delivered to the object to be heated through the upper surface of the cover plate 104. The cover plate 104 may be made of glass; however, embodiments are not limited thereto.

An input interface 1041 configured to receive an input from a user may be disposed on the upper surface of the cover plate 104. The input interface 1041 may be recessed into the upper surface of the cover plate 104 and may display a specific image. The input interface 1041 may receive a touch input from the user, and the induction heating device 100 may be driven based on the received touch input.

More specifically, the input interface 1041 may be a module for inputting a heating intensity or a heating period, for example, desired by the user, and may be implemented as a physical button or a touch panel, for example. Additionally, the input interface 1041 may display a drive state of the induction heating device 100. For example, the input interface 1041 may be a thin film transistor liquid crystal display (TFT LCD); however, embodiments are not limited thereto.

Light display areas 1042a, 1042b, 1042c may be formed on the upper surface of the cover plate 104. Light source units (lighting units) 1043a, 1043b, 1043c may be disposed below the cover plate 104, and light emitted from the light source units 1043a, 1043b, 1043c may be delivered to the user through the light display areas 1042a, 1042b, 1042c.

The working coil 106a, 106b, 106c, 106d, 106e may be a heating unit that heats an object to the heated, and may be disposed in the case 102. The working coil 106a, 106b, 106c, 106d, 106e may include a wire wound multiple times in a ring shape, and may generate an alternating current (AC) magnetic field. Additionally, a mica sheet and a ferrite core may be consecutively disposed at a lower side of the working coil 106a, 106b, 106c, 106d, 106e.

The ferrite core may be fixed to the mica sheet through a sealant, and may diffuse the AC magnetic field generated by the working coil 106a, 106b, 106c, 106d, 106e. The mica sheet may be fixed to the working coil 106a, 106b, 106c, 106d, 106e and the ferrite core through a sealant, and may prevent direct delivery of the heat, generated by the working coil 106a, 106b, 106c, 106d, 106e, to the ferrite core.

A plurality of working coils 106a, 106b, 106c, 106d, 106e may be provided. The plurality of working coils 106a, 106b, 106c, 106d, 106e may include first working coil 106a disposed at a central portion of the case 102, second working coil 106b and third working coil 106c disposed on a right (first) side of the first working coil 106a, and a fourth working coil 106d and a fifth working coil 106e disposed on a left (second) side of the first working coil 106a. The second working coil 106b and the third working coil 106c may be disposed on the right side of the first working coil 106a in a frontward-rearward direction, and the fourth working coil 106d and the fifth working coil 106e may be disposed on the left side of the first working coil 106a in the frontward-rearward direction.

For example, the first working coil 106a may be a high-output dual heating coil, and the second working coil 106b, the third working coil 106c, the fourth working coil 106d, and the fifth working coil 106e may each be a single heating coil. The first working coil 106a as a dual heating coil has a heavy weight, and may have a maximum output of 7000 kW.

The induction heating device 100 according to an embodiment may perform the function of wireless power transmission based on configurations and features described above. Technologies for wirelessly supplying power have been developed and have been used for a wide range of electronic devices. A battery of an electronic device, to which the wireless power transmitting technology is applied, can be charged only by being placed on a charge pad without connecting to an additional charge connector. Accordingly, the electronic device, to which the wireless power transmitting technology is applied, requires no cord or no charger, thereby ensuring improved mobility and a reduced size and weight.

The wireless power transmitting technology can be broadly classified as an electromagnetic induction technology using a coil, a resonance technology using resonance, and a radio emission technology for converting electric energy into microwaves and delivering the microwaves, for example. In the electromagnetic induction technology, power is transmitted using electromagnetic induction between a primary coil, that is, a working coil, included in an apparatus for wirelessly transmitting power and a secondary coil included in an apparatus for wirelessly receiving power.

The theory of the induction heating technology of the induction heating device 100 is substantially the same as that of the electromagnetic induction-based wireless power transmission technology, in that an object to be heated is heated using electromagnetic induction. Accordingly, the induction heating device 100 according to an embodiment may perform the function of wireless power transmission, as well as the function of induction heating.

The base plate 108a, 108b, 108c may be disposed in the case 102, for example, at a middle end or middle portion of the case 102. That is, the base plate 108a, 108b, 108c may be disposed in the case 102 below the cover plate 104, and the plurality of working coils 106a, 106b, 106c, 106d, 106e may be disposed in an upper portion of or above or on the base plate 108a, 108b, 108c. The base plate 108a, 108b, 108c may support the plurality of working coils 106a, 106b, 106c, 106d, 106e which are heavy, and may help the plurality of working coils 106a, 106b, 106c, 106d, 106e to be mounted. The input interface 1041 and the light source units 1043a, 1043b, 1043c may be further disposed at the upper portion of the base plate 108a, 108b, 108c.

According to an embodiment, a plurality of base plates 108a, 108b, 108c may be provided. For example, the plurality of base plates 108a, 108b, 108c may include first base plate 108a, second base plate 108b, and third base plate 108c.

The first base plate 108a, the second base plate 108b, and the third base plate 108c may be disposed at the middle end of the case 102 side by side to entirely cover a cross-sectional area of the case 102, for example, the middle end of the case 102. That is, the first base plate 108a, the second base plate 108b, and the third base plate 108c may be disposed such that an edge or side of the third base plate 108c is in contact with or directly adjacent to one edge or side of the first base plate 108a and an edge or side of the second base plate 108b is in contact with or directly adjacent to the other edge or side of the first base plate 108a opposite to the one edge or side. Thus, the first base plate 108a may be disposed in between of the second base plate 108b and the third base plate 108c.

The first base plate 108a may be disposed at a central portion of the end of the case 102. The first working coil 106a may be disposed at an upper portion of the first base plate 108a.

The input interface 1041, and first light source unit 1043a corresponding to the first working coil 106a may be further disposed in the upper portion of the first base plate 108a. The first base plate 108a may have a through hole 1081a for installing the input interface 1041 and the first light source unit 1043a.

The second base plate 108b may be disposed on a right (first) side of the first base plate 108a at the end of the case 102. The second working coil 106b and the third working coil 106c may be disposed at an upper portion of the second base plate 108b.

A second light source unit 1043b corresponding to the second working coil 106b and the third working coil 106c may be further disposed in the upper portion of the second base plate 108b. In the upper portion of the second base plate 108b, the second working coil 106b, the third working coil 106c, and the second light source unit 1043b may be consecutively disposed. The second base plate 108b may have a through hole 1081b for installing the second light source unit 1043b.

The third base plate 108c may be disposed on a left (second) side of the first base plate 108a at the end of the case 102. The fourth working coil 106d and the fifth working coil 106e may be disposed at an upper portion of or above or on the third base plate 108c.

A third light source unit 1043c corresponding to the fourth working coil 106d and the fifth working coil 106e may be further disposed at the upper portion of the third base plate 108c. In the upper portion of the third base plate 108c, the fourth working coil 106d, the fifth working coil 106e, and the third light source unit 1043c may be consecutively disposed. The third base plate 108c may have a through hole 1081c for installing the third light source unit 1043c.

The case 102 may have a plurality of mounting portions 1021 to mount the plurality of base plates 108a, 108b, 108c at side surfaces of the case 102. Each of the plurality of mounting portions 1021 may have a shape bent inward from the side of the case 102. A height of the plurality of mounting portions 1021 may be the same with respect to a lower surface of the case 102. That is, edges of the plurality of base plates 108a, 108b, 108c may be mounted onto a top of the plurality of mounting portions 1021. Accordingly, the plurality of base plates 108a, 108b, 108c may be disposed at the middle end of the case 102.

The case 102 may include a bracket 1022 at a central portion of a lower surface (bottom surface) or of a lower end of the case 102. The bracket 1022 may be disposed at a central portion of a lower side of the first base plate 108a, and may prevent a sagging of the lower surface of the first base plate 108a, caused by a weight of the first base plate 108a. The weight of the first base plate 108a may include a weight of the first working coil 106a in the upper portion the first base plate 108a. The second and third base plate 108c and 108b located at outer sides of the electric range may be supported by the mounting portions 1021 respectively at two edges facing each other as well as along one edge connecting these two edges. However, the first base plate 108a located in or at a center of the electric range, that is, between the second and third base plates 108b and 108c, may be supported by the mounting portions 1021 at two edges facing each other, while edges connecting the two edges remain unsupported. For this reason, it is advantageous to provide additional support of the first base plate 108a by means of the bracket 1022.

The bracket 1022 may include at least one elastic element 1025 on a top of the bracket 1022. For example, the elastic element 1025 may be a leaf spring. An upper end of at least one elastic element 1025 may contact the lower surface of the first base plate 108a, and may prevent a sagging of the lower surface of the first base plate 108a.

The drive circuit 110a, 110b, 110c may control driving of the plurality of working coils 106a, 106b, 106c, 106d, 106e which are heating units, and may further control driving of components, such as an input interface 1041, for example, of the induction heating device 100. The drive circuit 110a, 110b, 110c may include various components in relation to the driving of the working coils 106a, 106b, 106c, 106d, 106e. The components may include a power supply configured to supply AC power, a rectifier configured to rectify AC power of the power supply into direct current (DC) power, an inverter configured to convert DC power, rectified by the rectifier, into resonance current as a result of a switching operation and supply the resonance current to the working coil 106, a microcomputer, for example, a micom, configured to control the inverter and components in relation to driving of the inverter, and a relay or a semiconductor switch configured to turn on or turn off the working coils 106a, 106b, 106c, 106d, 106e, for example. Various types of components may be mounted onto a board of the drive circuit 110a, 110b, 110c.

The drive circuit 110a, 110b, 110c may include first drive circuit 110a, second drive circuit 110b, and third drive circuit 110c. The first drive circuit 110a may be disposed on a right (first) side of the case 102, for example, on a right (first) side of the lower surface of the case 102, with respect to the bracket 1022 and may control driving of the first working coil 106a. The second drive circuit 110b may be disposed on the right side of the first drive circuit 110a and may control driving of the second working coil 106b and the third working coil 106c. The third drive circuit 110c may be disposed on a left (second) side of the case 102, for example, on a left (second) side of the lower surface of the case 102, with respect to the bracket 1022 and may control driving of the fourth working coil 106d and the fifth working coil 106e.

The heat sink 112a, 112b, 112c may be disposed over at least a portion of the drive circuit 110a, 110b, 110c and may prevent an increase in temperatures of components disposed at at least a portion of the drive circuit 110a, 110b, 110c.

The heat sink 112a, 112b, 112c may include first heat sink 112a, second heat sink 112b, and third heat sink 112c. The first heat sink 112a may prevent an increase in temperatures of components installed in at least a portion of the first drive circuit 110a, the second heat sink 112b may prevent an increase in temperatures of components installed in at least a portion of the second drive circuit 110b, and the third heat sink 112c may prevent an increase in temperatures of components installed in at least a portion of the third drive circuit 110c.

The power feeder 114 may supply an external power source to the induction heating device 100. The power feeder 114 may be implemented as a terminal block, for example.

The power feeder 114 may be disposed at any one of edges of the case 102, for example, at the rear end of the case 102 or on the lower surface of the case 102. For example, the power feeder 114 may be disposed at a rear end of the left side of the lower surface of the case 102.

The filter circuit 116a, 116b, 116c may be disposed at any one of the edges of the lower end of the case 102, and may reduce noise made by the plurality of working coils 106a, 106b, 106c, 106d, 106e. The filter circuit 116a, 116b, 116c may include first filter circuit 116a, second filter circuit 116b, and third filter circuit 116c.

The first filter circuit 116a may reduce noise made by the first working coil 106a. The second filter circuit 116b may reduce noise made by the second working coil 106b and the third working coil 106c. The third filter circuit 116c may reduce noise made by the fourth working coil 106d and the fifth working coil 106e.

The air blowing fan 118a, 118b, 118c may reduce a temperature inside of the case 102. Accordingly, the air blowing fan 118a, 118b, 118c may lower a temperature of various components installed in the drive circuits 110a, 110b, 110c.

The air blowing fan 118a, 118b, 118c may be disposed below or on the lower side of the working coils 106a, 106b, 106c, 106d, 106e. The air blowing fan 118a, 118b, 118c may be disposed on the lower surface of the case 102, for example, on a front side or edge thereof.

The air blowing fan 118a, 118b, 118c may reduce a temperature inside of the case 102. Accordingly, the air blowing fan 118a, 118b, 118c may lower a temperature of various components installed in or on the drive circuits 110a, 110b, 110c.

The air blowing fan 118a, 118b, 118c may include first air blowing fan 118a, second air blowing fan 118b, and third blow fan 118c. The first air blowing fan 118a may cool various components installed in or on the first drive circuit 110a and may further cool the first light source unit 1043a and the input interface 1041. More particularly, the first air blowing fan 118a may deliver air (wind) for cooking to the first heat sink 112a in or at an upper portion of the first drive circuit 110a.

The second air blowing fan 118b may cool various components installed in or on the second drive circuit 110b and may further cool the second light source unit 1043b. More particularly, the second air blowing fan 118b may deliver air for cooling to the second heat sink 112b in or at an upper portion of the second drive circuit 110b.

The third air blowing fan 118c may cool various components installed in or on the third drive circuit 110c and may further cool the third light source unit 1043c. More particularly, the third air blowing fan 118c may deliver air for cooling to the third heat sink 112c in or at an upper portion of the third drive circuit 110c. The air blowing fans 118a, 118b, 118c may not include structure for preventing a foreign substance from contacting the air blowing fans 118a, 118b, 118c.

The air guide 120a, 120b, 120c may guide air generated by the air blowing fans 118a, 118b, 118c. The air guide 120a, 120b, 120c may include first air guide 120a, second air guide 120b, and third guide 120c. The first air guide 120a may be disposed to encircle or surround or cover the first heat sink 112a installed in at least a portion of the first drive circuit 110a and may guide (deliver) air, output from the first air blowing fan 118a, to the first heat sink 112a. The second air guide 120b may be disposed to encircle or surround or cover the second heat sink 112b installed in at least a portion of the second drive circuit 110b and may guide air, output from the second air blowing fan 118b, to the second heat sink 112b. The third air guide 120c may be disposed to encircle or surround or cover the third heat sink 112c installed in at least a portion of the third drive circuit 110c and may guide air, output from the third air blowing fan 118c, to the third heat sink 112c.

The induction heating device 100 according to an embodiment has configurations and features described above. Hereinafter, description of prevention of sagging of the base plate 108a, 108b, 108c is provided.

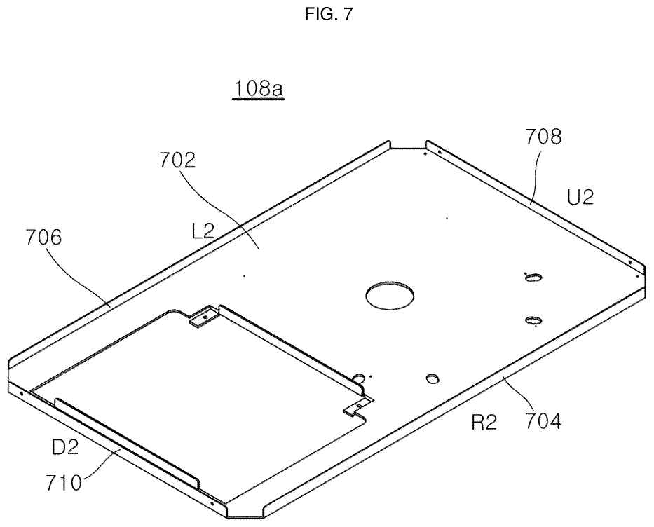

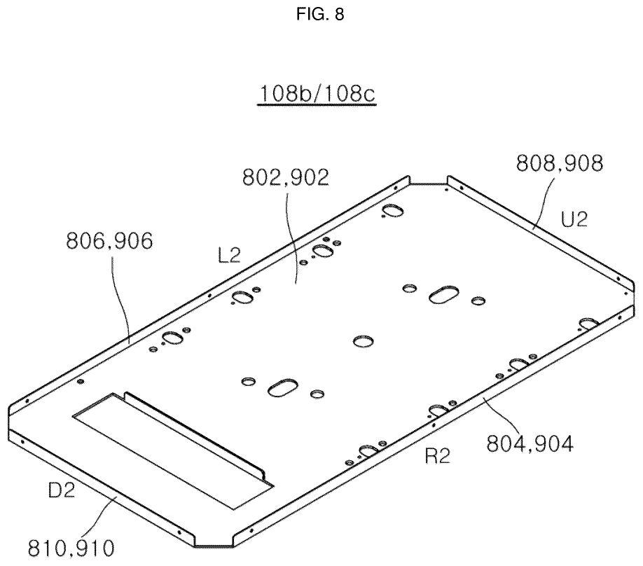

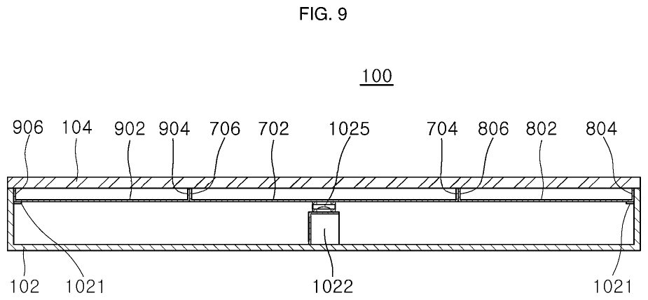

FIG. 7 is a perspective view of first base plate 108a according to an embodiment. FIG. 8 is a perspective view of second base plate 108b and third base plate 108c according to an embodiment. FIG. 9 is a cross-sectional view of base plate 108a, 108b, 108c disposed in case 102, according to an embodiment.

The base plate 108a, 108b, 108c illustrated in FIGS. 7 to 9 may have the same shape as base plate 108a, 108b, 108c described with reference to FIGS. 3 to 5. Referring to FIG. 8, the second base plate 108b and the third base plate 108c may have the same shape.

Referring to FIGS. 7 to 9, the base plate 108a, 108b, 108c according to an embodiment may include a flat plate 702, 802, 902 and a plurality of bent portions 704, 706, 708, 710, 804, 806, 808, 810, 904, 906, 908, 910.

A right (or first) bent portion 704, 804, 904 of the base plate 108a, 108b, 108c may be bent at a right (or first) edge R2 of the flat plate 702, 802, 902, a left (or second) bent portion 706, 806, 906 of the base plate 108a, 108b, 108c may be bent at a left (or second) edge L2 of the flat plate 702, 802, 904, an upper (or third) bent portion 708, 808, 908 of the base plate 108a, 108b, 108c may be bent at an upper (or third) edge U2 of the flat plate 702, 802, 902, and a lower (or fourth) bent portion 710, 810, 910 of the base plate 108a, 108b, 108c may be bent at a lower (or fourth) edge D2 of the flat plate 702, 802, 902. In this case, the plurality of bent portions 704, 706, 708, 710, 804, 806, 808, 810, 904, 906, 908, 910 may serve as a strength line. Accordingly, a strength of the base plate 108a, 108b, 108c may be improved.

According to another embodiment, one or more bent portions among the plurality of bent portions 704, 706, 708, 710, 804, 806, 808, 810 may not be provided.

According to one embodiment, the plurality of bent portions 704, 706, 708, 710, 804, 806, 808, 810, 904, 906, 908, 910 of the base plate 108a, 108b, 108c may be bent upward, that is, in a direction opposite to the direction of gravity, that is, towards the cover plate 104. That is, the flat plate 702, 804, 904 may have a flat shape and the plurality of bent portions 704, 706, 708, 710, 804, 806, 808, 810, 904, 906, 908, 910 may be bent at an angle, for example, of 90°, in a direction opposite to the direction of gravity; however, embodiments are not limited thereto. Alternatively, the plurality of bent portions 704, 706, 708, 710, 804, 806, 808, 810, 904, 906, 908, 910 may be bent downward, that is, in the direction of gravity, that is, in a direction away from the cover plate 104.

Referring to FIG. 4 and FIGS. 7 to 9, an upper edge U2 of the first base plate 108a may be mounted onto a mounting portion 1021 formed on an upper side surface, that is, first side surface U1, of the case 102, and upper bent portion 708 of the first base plate 108a may be disposed near the upper side surface U1 of the case 102. A lower edge D2 of the first base plate 108a may be mounted onto a mounting portion 1021 formed on a lower side surface, that is, second side surface D1, of the case 102, and lower bent portion 710 of the first base plate 108a may be disposed near the lower side surface D1 of the case 102. The upper side surface U1 of the case 102 and the lower side surface D1 of the case 102 are opposite to each other, that is, face each other.

An upper edge U2 of the second base plate 108b may be mounted onto a mounting portion 1021 formed on the upper side surface U1 of the case 102, and upper bent portion 808 of the second base plate 108b may be disposed near the upper side surface U1 of the case 102. A lower edge D2 of the second base plate 108b may be mounted onto a mounting portion 1021 formed on the lower side surface D1 of the case 102, and lower bent portion 810 of the second base plate 108b may be disposed near the lower side surface D1 of the case 102. A right edge R2 of the second base plate 108b may be mounted onto a mounting portion 1021 formed on a right side surface, that is, third side surface R1, of the case 102, and right bent portion 806 of the second base plate 108b may be disposed near the right side surface R1 of the case 102.

The mounting portion 1021 onto which the upper edge U2 of the second base plate 108b is mounted may be the same as the mounting portion 1021 onto which the upper edge U2 of the first base plate 108a is mounted, and the mounting portion 1021 onto which the lower edge D2 of the second base plate 108b is mounted may be the same as the mounting portion 1021 onto which the lower edge D2 of the first base plate 108a is mounted. Accordingly, the first base plate 108a and the second base plate 108b may be disposed in the case 102 at a same height.

An upper edge U2 of the third base plate 108c may be mounted onto a mounting portion 1021 formed on the upper side surface U1 of the case 102, and upper bent portion 908 of the third base plate 108c may be disposed near the upper side surface U1 of the case 102. A lower edge D2 of the third base plate 108c may be mounted onto a mounting portion 1021 formed on the lower side surface D1 of the case 102, and lower bent portion 910 of the third base plate 108c may be disposed near the lower side surface D1 of the case 102. A left edge L2 of the third base plate 108c may be mounted onto a mounting portion 1021 formed on a left side surface, that is, fourth side surface L1 of the case 102, and left bent portion 906 of the third base plate 108c may be disposed near the left side surface L1 of the case 102.

The mounting portion 1021 onto which the upper edge U2 of the third base plate 108c is mounted may be the same as the mounting portion 1021 onto which the upper edge U2 of the first base plate 108a is mounted, and the mounting portion 1021 onto which the lower edge D2 of the third base plate 108c is mounted may be the same as the mounting portion 1021 onto which the lower edge D2 of the first base plate 108a is mounted. Accordingly, the first base plate 108a and the third base plate 108c may be disposed in the case 102 at a same height. As the height of the plurality of mounting portions 1021 is the same, the first base plate 108a, the second base plate 108b, and the third base plate 108c may be disposed in the case 102 at the same height by the plurality of mounting portions 1021.

A right edge R2 of the first base plate 108a may be disposed near a left edge L2 of the second base plate 108b, and right bent portion 704 of the first base plate 108a may be disposed to face left bent portion 806 of the second base plate 108b. A left edge L2 of the first base plate 108a may be disposed near a right edge R2 of the third base plate 108c, and left bent portion 706 of the first base plate 108a may be disposed to face right bent portion 904 of the third base plate 108c.

In summary, the induction heating device 100 according to this embodiment may use a plurality of divided base plates 108a, 108b, 108c instead of using a single base plate, to mount working coils 106a, 106b, 106c, 106d, 106e. As a large-sized base plate has less strength than a small-sized base plate, the induction heating device 100 according to embodiments disclosed herein may prevent sagging of the base plate 108a, 108b, 108c. As a result of prevention of sagging of the base plate 108a, 108b, 108c, heat generated by the working coil 106a, 106b, 106c, 106d, 106e may be effectively delivered to the cover plate 104.

In the induction heating device 100 according to this embodiment, ends of the base plate 108a, 108b, 108c may be bent upward. The bent ends of the base plate 108a, 108b, 108c, that is, the bent portions 704, 706, 708, 710, 804, 806, 808, 810, 904, 906, 908, 910, may serve as a strength line for the flat plate 702, 802, 902.

In other words, the plurality of bent portions 704, 706, 708, 710, 804, 806, 808, 810, 904, 906, 908, 910 may be formed at the edges or ends of the flat plate 702, 802, 902 of the base plate 108a, 108b, 108c, and at least a portion of one or more bent portions among the plurality of bent portions 704, 706, 708, 710, 804, 806, 808, 810, 904, 906, 908, 910 may be disposed to contact an inner surface of the case 102. In a base plate A and a base plate B adjacent to each other among the base plates 108a, 108b, 108c, a bent portion of the base plate A and a bent portion of the base plate B may be disposed to at least partially contact each other. In this case, the bent portion of the base plate A and the bent portion of the base plate B may be bent portions formed between the base plate A and the base plate B. As each of the bent portions 704, 706, 708, 710, 804, 806, 808, 810, 904, 906, 908, 910 may contact the inner surface of the case 102 or another bent portion, the strength of the base plate 108a, 108b, 108c may improve, and sagging of the base plate 108a, 108b, 108c may be further prevented.

According to embodiments disclosed herein, as the plurality of base plates 108a, 108b, 108c is used, the induction heating device 100 may be readily manufactured and assembled. That is, when a single base plate is disposed in a case 102, it is not easy to assemble an induction heating device due to the weight of the single base plate. However, according to embodiments disclosed herein, as a plurality of lightweight base plates 108a, 108b, 108c may be used, the induction heating device 100 may be readily assembled.

Additionally, in the induction heating device 100 according to embodiments disclosed herein, no additional work for improving the strength of the plurality of base plates 108a, 108b, 108c is required. That is, according to embodiments disclosed herein, the strength of the plurality of base plates 108a, 108b, 108c may improve without adding a rib, or a bead, for example, for improving strength.

Further, in the induction heating device 100 according to embodiments disclosed herein, the plurality of base plates 108a, 108b, 108c may be disposed side by side to cover an entire surface area of the case 102. Accordingly, noise between the working coils 106a, 106b, 106c, 106d, 106e and electronic components disposed below the plurality of base plates 108a, 108b, 108c may be completely blocked. Further, as the electronic components may be freely disposed, a size of the case 102 may be reduced, and a small-sized induction heating device 100 may be manufactured. As a result, a space for installing the induction heating device 100 may be reduced.

The bracket 1022, as described above, may be disposed in the central portion of the lower end of the case 102.

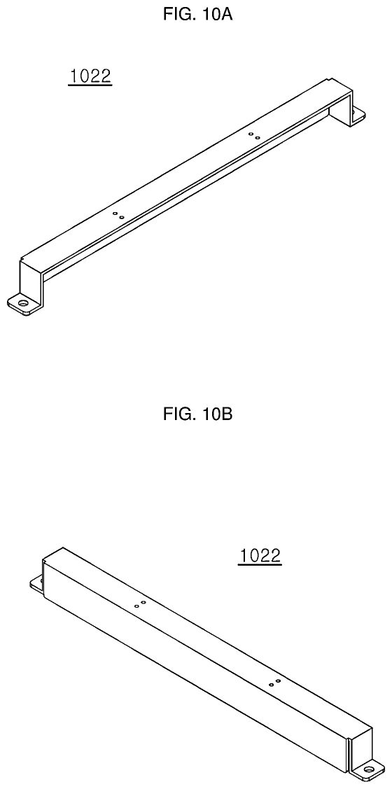

FIGS. 10A-10B are perspective views showing bracket 1022 according to an embodiment. Referring to FIGS. 10A-10B, a lower surface of the bracket 1022 may be screw-coupled to a lower surface of the case 102. An upper surface of the bracket 1022 may have a flat shape, a left (first) surface of the bracket 1022 may have a shape that is bent at the upper surface of the bracket 1022 and a right (second) surface of the bracket 1022 may have an open shape; however, embodiments are not limited thereto. The left surface and right surface of the bracket 1022 may have a shape that is bent at the upper surface of the bracket 1022, and the left surface and right surface of the bracket 1022 may have an open shape.

The bracket 1022 may be disposed in a central portion of a lower side of the first base plate 108a and may support the first base plate 108a. The bracket 1022 may have at least one elastic element 1025 on the upper surface thereof. An upper end of at least one elastic element 1025 may contact the lower surface of the first base plate 108a. Depending on elastic properties, the elastic element 1025 may further support the first base plate 108a.

In summary, as the induction heating device 100 according to this embodiment is provided with the bracket 1022 and at least one elastic element 1025, sagging of the first base plate 108a may be further prevented.

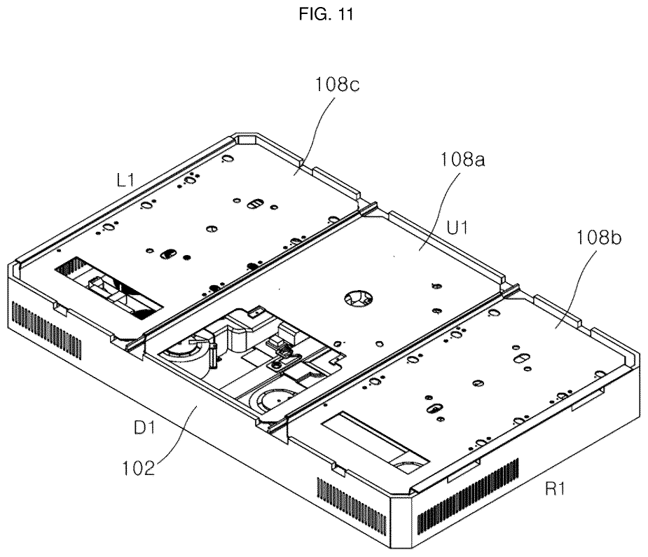

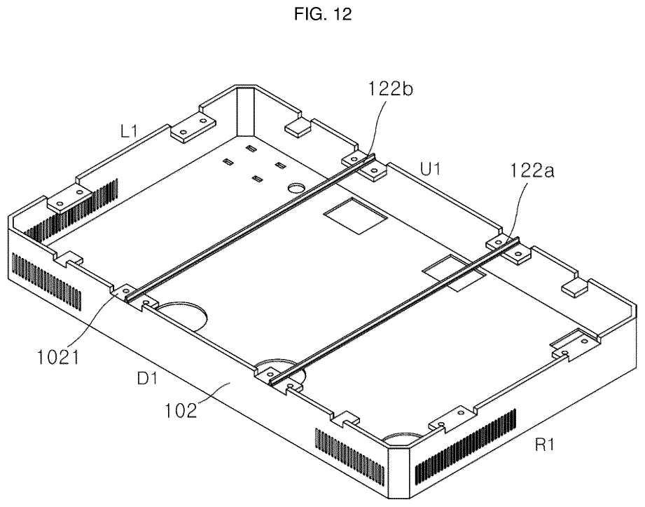

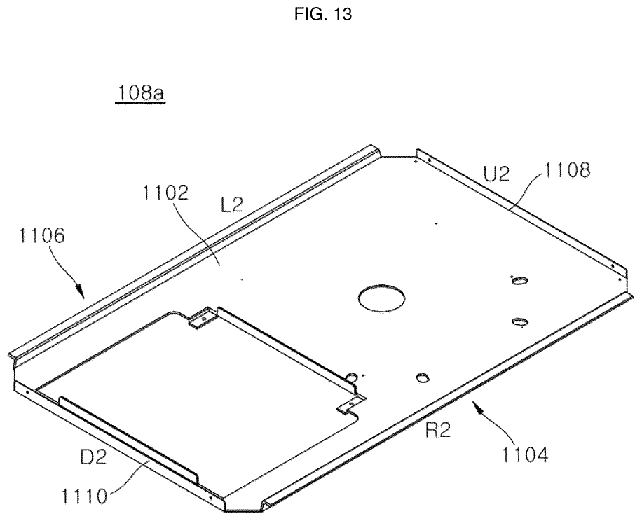

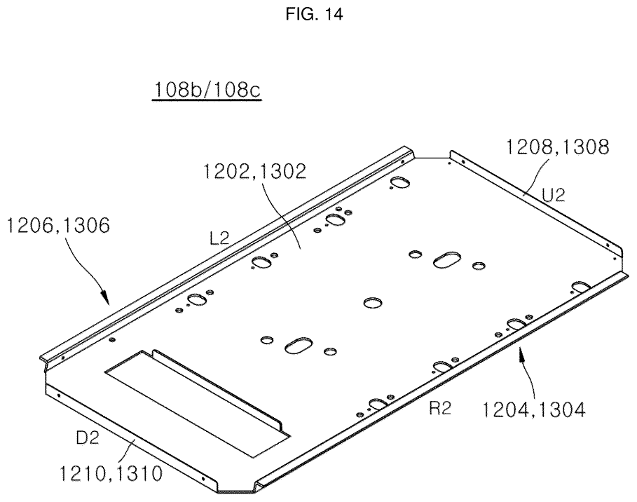

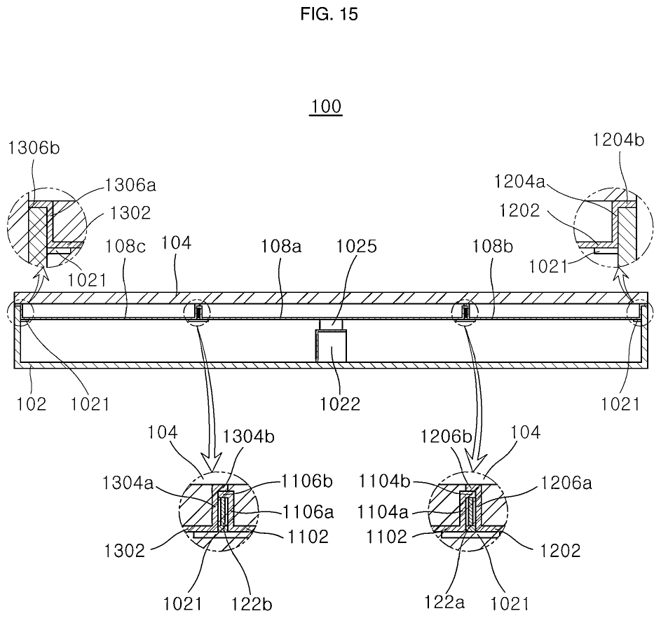

FIG. 11 is a perspective view showing case 102 in which base plate 108a, 108b, 108c according to another embodiment is disposed. FIG. 12 is a perspective view showing case 102 in which a reinforcement beam 122a, 122b is disposed, according to the another embodiment. FIG. 13 is a perspective view showing first base plate 108a according to the another embodiment. FIG. 14 is a perspective view showing second base plate 108b and third base plate 108c according to the another embodiment. FIG. 15 is a cross-sectional view showing base plate 108a, 108b, 108c disposed in case 102, according to the another embodiment. Referring to FIG. 14, the second base plate 108b and the third base plate 108c may have the same shape.

Referring to FIGS. 11 to 15, the base plate 108a, 108b, 108c according to this embodiment may include flat plate 1102, 1202, 1302 and a plurality of bent portions 1104, 1106, 1108, 1110, 1204, 1206, 1208, 1210, 1304, 1306, 1308, 1310. An upper (or first) bent portion 1108, 1208, 1308 of the base plate 108a, 108b, 108c may be bent at an upper (or first) edge U2 of the flat plate 1102, 1202, 1302, and a lower (or second) bent portion 1110, 1210, 1310 of the base plate 108a, 108b, 108c may be bent at a lower (or second) edge D2 of the flat plate 1102, 1202, 1302. The upper bent portion 1108, 1208, 1308 and lower bent portion 1110, 1210, 1310 of the base plate 108a, 108b, 108c according to this embodiment may be the same as the upper bent portion 708, 808, 908 and lower bent portion 710, 810, 910 of the base plate 108a, 108b, 108c according to the previous embodiment. Accordingly, description in relation to this has been omitted. Alternatively, the upper bent portion 1108, 1208, 1308 and lower bent portion 1110, 1210, 1310 of the base plate 108a, 108b, 108c according to this embodiment may have a stepped shape configuration like a left (or third) bent portion 1104, 1204, 1304 and a right (or fourth) bent portion 1106, 1206, 1306 described hereinafter.

A left (or third) bent portion 1104, 1204, 1304 and a right (or fourth) bent portion 1106, 1206, 1306 of the base plate 108a, 108b, 108c may be bent in a stepped shape, for example, in a Z shape or an inverse Z shape. The left bent portion 1104, 1204, 1304 and the right bent portion 1106, 1206, 1306 may have the same shape, but mirrored with respect to a vertical line. For example, the left bent portion 1104, 1204, 1304 of the base plate 108a, 108b, 108c may be bent in a Z shape, and the right bent portion 1106, 1206, 1306 of the base plate 108a, 108b, 108c may be bent in an inverse Z shape.

More specifically, referring to FIGS. 11, 13, 14 and 15, the first base plate 108a may include a first flat plate 1102, a (1-1)th bent portion 1104a, a (1-2)th bent portion 1104b, a (1-3)th bent portion 1106a, and a (1-4)th bent portion 1106b. The (1-1)th bent portion 1104a and (1-2)th bent portion 1104b may correspond to the right bent portion 1104 of the first base plate 108a, and the (1-3)th bent portion 1106a and (1-4)th bent portion 1106b may correspond to the left bent portion 1106 of the first base plate 108a.

One (first) end of the bent portion 1104a may be bent at a right (first) end of the first flat plate 1102, for example, at an angle of 90°, and one (first) end of the (1-2)th bent portion 1104b may be bent at the other (second) end of the (1-1)th bent portion 1104a, for example, at angle of 90°. Accordingly, the right end of the first flat plate 1102, and the (1-1)th bent portion 1104a and the (1-2)th bent portion 1104b may have an inverse Z shape.

One (first) end of the bent portion 1106a may be bent at a left (first) end of the first flat plate 1102, for example, at an angle of 90°, and one (first) end of the (1-4)th bent portion 1106b may be bent at the other (second) end of the (1-3)th bent portion 1106a, for example, at an angle of 90°. Accordingly, the left end of the first flat plate 1102, and the (1-3)th bent portion 1106a and the (1-4)th bent portion 1106b may have a Z shape. Additionally, the second base plate 108b may include a second flat plate 1202, a (2-1)th bent portion 1204a, a (2-2)th bent portion 1204b, a (2-3)th bent portion 1206a, and a (2-4)th bent portion 1206b. The (2-1)th bent portion 1204a and (2-2)th bent portion 1204b may correspond to the right bent portion 1204 of the second base plate 108b, and the (2-3)th bent portion 1206a and (2-4)th bent portion 1206b may correspond to the left bent portion 1206 of the second base plate 108b.

One (first) end of the (2-1)th bent portion 1204a may be bent at a right (first) end of the second flat plate 1202, for example, at an angle of 90°, and one (first) end of the (2-2)th bent portion 1204b may be bent at the other (second) end of the (2-1)th bent portion 1204a, for example, at angle of 90°. Accordingly, the right end of the second flat plate 1202, and the (2-1)th bent portion 1204a and the (2-2)th bent portion 1204b may have an inverse Z shape.

One (first) end of the (2-3)th bent portion 1206a may be bent at a left (second) end of the second flat plate 1202, for example, at an angle of 90°, and one (first) end of the (2-4)th bent portion 1206b may be bent at the other (second) end of the (2-3)th bent portion 1206a, for example, at angle of 90°. Accordingly, the left end of the second flat plate 1202, and the (2-3)th bent portion 1206a and the (2-4)th bent portion 1206b may have a Z shape.

Further, the third base plate 108c may include a third flat plate 1302, a (3-1)th bent portion 1304a, a (3-2)th bent portion 1304b, a (3-3)th bent portion 1306a, and a (3-4)th bent portion 1306b. The (3-1)th bent portion 1304a and (3-2)th bent portion 1304b may correspond to the right bent portion 1304 of the third base plate 108c, and the (3-3)th bent portion 1306a and (3-4)th bent portion 1306b may correspond to the left bent portion 1306 of the third base plate 108c.

One (first) end of the (3-1)th bent portion 1304a may be bent at a right (first) end of the third flat plate 1302, for example, at an angle of 90°, and one (first) end of the (3-2)th bent portion 1304b may be bent at the other (second) end of the (3-1)th bent portion 1304a, for example, at angle of 90°. Accordingly, the right end of the third flat plate 1302, and the (3-1)th bent portion 1304a and the (3-2)th bent portion 1304b may have an inverse Z shape.

One (first) end of the (3-3)th bent portion 1306a may be bent at a left (first) end of the third flat plate 1302, for example, at an angle of 90°, and one (first) end of the (3-4)th bent portion 1306b may be bent at the other (second) end of the (3-3)th bent portion 1306a, for example, at angle of 90°. Accordingly, the left end of the third flat plate 1302, and the (3-3)th bent portion 1306a and the (3-4)th bent portion 1306b may have a Z shape.

The bent portion 1104a and the (2-3)th bent portion 1206a may be disposed in parallel, and the (2-4)th bent portion 1206b may be mounted onto the (1-2)th bent portion 1104b; however, embodiments are not limited thereto. Alternatively, the (1-2)th bent portion 1104b may be mounted onto the (2-4)th bent portion 1206b.

The bent portion 1106a and the (3-1)th bent portion 1304a may be disposed in parallel, and the (3-2)th bent portion 1304b may be mounted onto the (1-4)th bent portion 1106b; however, embodiments are not limited thereto. Alternatively, the (1-4)th bent portion 1106b may be mounted onto the (3-2)th bent portion 1304b.

The (2-1)th bent portion 1204a may be disposed to face the right side surface R1 of the case 102, and the (2-2)th bent portion 1204b may be mounted onto the right side surface R1 of the case 102. The (3-3)th bent portion 1306a may be disposed to face the left side surface L1 of the case 102, and the (3-4)th bent portion 1306b may be mounted onto the left side surface L1 of the case 102.

The right bent portion 1204 of the second base plate 108b may only include the (2-1)th bent portion 1204a. The left bent portion 1306 of the third base plate 108c may only include the (3-3)th bent portion 1306a.

In summary, the induction heating device 100 according to this embodiment may have the same features as the induction heating device 100 according to the previous embodiment. The features are described as follows. The plurality of base plates 108a, 108b, 108c may be provided to prevent sagging of the base plate 108a, 108b, 108c, the ends of the base plate 108a, 108b, 108c may be bent to further prevent sagging of the base plate 108a, 108b, 108c, the plurality of lightweight base plates 108a, 108b, 108c may be used to help readily manufacture and assemble the induction heating device 100, additional work for improving strength of the plurality of base plates 108a, 108b, 108c may not be required, and noise between the working coil 106a, 106b, 106c, 106d, 106e and electronic components below the plurality of base plates 108a, 108b, 108c may be completely blocked.

Additionally, in the induction heating device 100 according to this embodiment, the right and left ends of the base plate 108a, 108b, 108c may be disposed in a Z shape or an inverse Z shape. In this case, the structures of the right and left ends may allow the base plates 108a, 108b, 108c to complement and support one another. Thus, sagging of the base plate 108a, 108b, 108c may be further prevented, and the base plates 108a, 108b, 108c may be stably mounted onto the case.

The induction heating device 100 according to this embodiment may include first reinforcement beam 122a and second reinforcement beam 122b. One (first) end of the first reinforcement beam 122a and the second reinforcement beam 122b may connect to the upper side surface U1 of the case 102, and the other (second) end of the first reinforcement beam 122a and the second reinforcement beam 122b may connect the lower side surface D1 of the case 102. For example, the one end of the first reinforcement beam 122a and the second reinforcement beam 122b may be screw-coupled to the mounting portion 1021 formed on the upper side surface U1 of the case 102, and the other end of the first reinforcement beam 122a and the second reinforcement beam 122b may be screw-coupled to the mounting portion 1021 formed on the lower side surface D1 of the case 102.

The first reinforcement beam 122a may be disposed between the (1-1)th bent portion 1104a and the (2-3)th bent portion 1206a, and an upper end of the first reinforcement beam 122a may contact a lower portion of the (1-2)th bent portion 1104b. When the (1-2)th bent portion 1104b is mounted onto the (2-4)th bent portion 1206b, the upper end of the first reinforcement beam 122a may contact a lower portion of the (2-4)th bent portion 1206b. The first reinforcement beam 122a may have a “L” shape.

The second reinforcement beam 122b may be disposed between the (1-3)th bent portion 1106a and the (3-1)th bent portion 1304a, and an upper end of the second reinforcement beam 122b may contact a lower portion of the (1-4)th bent portion 1106b. When the (1-4)th bent portion 1106b is mounted onto the (3-2)th bent portion 1304b, the upper end of the second reinforcement beam 122b may contact a lower portion of the (3-2)th bent portion 1304b. The second reinforcement beam 122b may have a “ [symbol] ” shape.

In summary, in the induction heating device 100 according to this embodiment, the reinforcement beam 122a, 122b may be disposed between the ends of each of the base plates 108a, 108b, 108c, and may support the bent portions. Thus, sagging of the base plates 108a, 108b, 108c may be further prevented.

Embodiments disclosed herein provide an electric range that may ensure prevention of sagging (a bend) of a base plate, on which a heating unit is mounted, in the direction of gravity. Embodiments disclosed herein further provide an electric range that may effectively deliver heat, generated by a heating unit, to a cover plate. Embodiments disclosed herein further provide an electric range in which a base plate may be readily installed in a case.

Advantages are not limited to the above ones, and other advantages that are not mentioned above may be clearly understood from the description and can be more clearly understood from the embodiments set forth herein.

One or more of these advantages are solved by the features. An electric range according to embodiments disclosed herein may use a plurality of divided base plates instead of a single base plate, thereby preventing sagging of the base plate in the direction of gravity.

In the electric range according to embodiments disclosed herein, at least one end of each of the plurality of base plates may be bent, thereby further preventing sagging of the base plate and improving strength of the base plate. At least one end of each of the plurality of base plates may be bent in a Z shape or an inverse Z shape, thereby further preventing sagging of the base plate and disposing the plurality of base plates in a case stably.

The electric range may include a reinforcement beam between adjacent base plates, thereby disposing the plurality of base plates in the case more stably. In the electric range according to embodiments disclosed herein, the plurality of base plates may be mounted onto a plurality of mounting portions having a same height, thereby mounting the plurality of base plates into the case without causing a difference in heights of the base plates.

The electric range may use the plurality of lightweight base plates, thereby the electric range may be readily manufacture and assembled. The plurality of base plates may be disposed side by side to cover an entire surface area of the case, thereby completely blocking noise between a heating unit and electronic components below the base plate. Further, electronic components may be freely disposed, and a size of the case may be reduced and a small-sized electric range may be manufactured.

Embodiments disclosed herein provide an electric range that may include a case; a cover plate coupled to the case onto which an object to be heated may be placed; a plurality of heating units accommodated in the case and disposed below the cover plate to heat the object; and a plurality of base plates disposed in and/or coupled to the case. The heating units may be disposed on the base plates, that is, disposed in an upper portion thereof. An area of the plurality of base plates may correspond to a cross-sectional area of the case, for example, in a horizontal plane. The plurality of base plates may be disposed side by side to extend from one side surface of the case to another side surface of the case opposite thereto, to cover a cross-sectional area of the case. That is, the plurality of base plates may be disposed in contact with each other and/or coupled to each other, and/or the plurality of base plates may be disposed in contact with the case and/or coupled to the case. The plurality of base plates may be disposed one adjacent to the other along a straight line, for example, from a left or first side surface of the case to a right or second side surface of the case.

Embodiments disclosed herein provide an electric range that may include a case; a cover plate coupled to an upper end of the case and allowing an object to be heated to be placed on an upper surface thereof; a plurality of heating units disposed below the cover plate and configured to heat the object to be heated; and a plurality of base plates disposed at a middle end of the case and provided with the plurality of heating units in an upper portion thereof. The plurality of base plates may be disposed side by side to entirely cover the middle end of the case.

Each of the plurality of base plates may include a flat plate and at least one bent portion formed at an end of the flat plate. Each of the plurality of base plates may include a flat plate and a plurality of bent portions formed respectively at a plurality of ends or edges of the flat plate.

The at least one bent portion may extend from the flat plate in vertical direction and/or at an angle of about 90°. The base plate(s) may be mounted within the case such that the flat plate(s) may extend in horizontal direction. At least a part or portion of one or more bent portions among the plurality of bent portions may be disposed to contact a side surface of the case.

Each of the base plates may include a bent portion in contact with and/or coupled to a bent portion of an adjacent base plate. Each of the bent portions formed on base plates adjacent to each other among the plurality of base plates may be disposed to contact each other and/or may be coupled to each other.

The plurality of base plates may include a first base plate, a second base plate, and a third base plate. The first base plate, the second base plate, and the third base plate may be arranged one after the other along a straight line. The first base plate may be disposed between the second base plate and the third base plate. That is, the plurality of base plates may include a first base plate, a second base plate on a right (first) side of the first base plate, and a third base plate on a left (second) side of the first base plate. At least one of a left end (or edge) and a right end (or edge) of each of the first base plate, the second base plate, and the third base plate may be bent.

At least one of the plurality of base plates may include a flat plate, a first bent portion extending from the flat plate in a vertical direction, and a second bent portion extending from the first bent portion in a horizontal direction such that the flat plate, the first bent portion, and the second bent portion form a stepped shape or a Z shape. The second bent portion may extend from the first bent portion in a direction away from the flat plate and/or in a direction towards an adjacent base plate. First bent portions formed at neighboring and/or parallel edges of adjacent base plates may have surfaces extending in parallel to each other, that is, in a vertical direction. Second bent portions formed at neighboring and/or parallel edges of adjacent base plates may be overlapping one another and/or in contact with one another and/or mounted at one another.

The first bent portion of at least one of the base plates which is formed at an edge of the base plate adjacent to a side surface of the case may be in surface contact with the side surface of the case. The second bent portion of at least one of the base plates which is formed at an edge of said base plate adjacent to a side surface of the case may bear or rest on an upper end of a side surface of the case.

The electric range may further include a reinforcement beam accommodated within the casing and having one (first) end connected to a first side surface of the case and the other (second) end connected to a second side surface of the case facing the first side surface. The reinforcement beam may be disposed between first bent portions formed at neighboring and/or parallel edges of adjacent base plates. The reinforcement beam may support at least one of the second bent portions formed at neighboring and/or parallel edges of adjacent base plates.

The first base plate may include a first flat plate, a (1-1)th bent portion, and a (1-2)th bent portion. The (1-1)th bent portion and the (1-2)th bent portion may correspond to or may be formed at the right end of the first base plate. One end of the (1-1)th bent portion may be bent at a right end of the first flat plate and one end of the (1-2)th bent portion may be bent at the other end of the (1-1)th bent portion. The right end of the first flat plate, the (1-1)th bent portion (1104a) and the (1-2)th bent portion may have a stepped shape or a Z shape or an inverse Z shape.

The second base plate may include a second flat plate, a (2-3)th bent portion, and a (2-4)th bent portion. The (2-3)th bent portion and the (2-4)th bent portion may correspond to or may be formed at the left end of the second base plate. One (first) end of the (2-3)th bent portion may be bent at a left (first) end of the second flat plate, and one (second) end of the (2-4)th bent portion may be bent at the other (second) end of the (2-3)th bent portion. The left end of the second flat plate, the (2-3)th bent portion, and the (2-4)th bent portion may have a stepped shape or a Z shape.

The (1-1)th bent portion (1104a) and the (2-3)th bent portion (1206a) may be disposed in parallel. The (1-2)th bent portion may be mounted onto the (2-4)th bent portion or the (2-4)th bent portion may be mounted onto the (1-2)th bent portion.

The electric range may further include a first reinforcement beam having one (first) end of which is connected to a first side surface of the case and the other (second) end of which is connected to a second side surface of the case facing the first side surface of the case. The first reinforcement beam may be disposed between the (1-1)th bent portion and the (2-3)th bent portion. An upper end of the first reinforcement beam may contact a lower portion of the (1-2)th bent portion or a lower portion of the (2-4)th bent portion.

The second base plate may further include a (2-1)th bent portion and a (2-2)th bent portion. The (2-1)th bent portion and the (2-2)th bent portion may correspond to the right end of the second base plate. One (first) end of the (2-1)th bent portion may be bent at a right (first) end of the second flat plate and/or one end of the (2-2)th bent portion may be bent at the other (second) end of the (2-1)th bent portion. The right end of the second flat plate, the (2-1)th bent portion, and the (2-2)th bent portion may have an inverse Z shape. The (2-2)th bent portion may be mounted onto a third side surface of the case.

The first base plate may further include a (1-3)th bent portion and a (1-4)th bent portion. The (1-3)th bent portion (1106a) and the (1-4)th bent portion (1106b) may correspond to the left end of the first base plate. One (first) end of the (1-3)th bent portion may be bent at a left (first) end of the first flat plate, and/or one (first) end of the (1-4)th bent portion may be bent at the other (second) end of the (1-3)th bent portion. The left end of the first flat plate, the (1-3)th bent portion and the (1-4)th bent portion may have a Z shape.

The third base plate may include a third flat plate, a (3-1)th bent portion, and a (3-2)th bent portion. The (3-1)th bent portion (1304a) and the (3-2)th bent portion may correspond to the right end of the second base plate. One (first) end of the (3-1)th bent portion may be bent at a right (a first) end of the third flat plate, and/or one (first) end of the (3-2)th bent portion may be bent at the other (second) end of the (3-1)th bent portion. The right end of the third flat plate, the (3-1)th bent portion, and the (3-2)th bent portion may have a Z shape.

The (1-3)th bent portion and the (3-1)th bent portion may be disposed in parallel. The (1-4)th bent portion may be mounted onto the (3-2)th bent portion or the (3-2)th bent portion may be mounted onto (1-4)th bent portion.

The electric range may further include a second reinforcement beam having one (first) end of which is connected to first side surface of the case and the other (second) end of which is connected to a second side surface of the case facing the first side surface of the case. The second reinforcement beam may be disposed between the (1-3)th bent portion and the (3-1)th bent portion. An upper end of the second reinforcement beam may contact a lower portion of the (1-4)th bent portion and/or a lower portion of the (3-2)th bent portion.

The third base plate may further include a (3-3)th bent portion and a (3-4)th bent portion. The (3-3)th bent portion and the (3-4)th bent portion may correspond to the left end of the third base plate. One (first) end of the (3-3)th bent portion may be bent at a left (first) end of the third flat plate, and/or one end of the (3-4)th bent portion may be bent at the other (second) end of the (3-3)th bent portion. The left end of the third flat plate, and the (3-3)th bent portion and the (3-4)th bent portion may have a Z shape. The (3-4)th bent portion may be mounted onto a left side surface of the case.

The electric range may be an electric resistance-type electric range or an induction heating-type electric range. Directional indication, such as height, heightwise or vertical direction, width, upper end, and lower end, for example, refer to an orientation when the electric range is in its operative state or position. In particular, a heightwise direction may also be referred to as a vertical direction. Width may denote a dimension in the horizontal direction, in particular in a horizontal direction parallel to a (vertical) front surface of the case of the electric range which will be facing a user during operation. Thus, left end and right end may denote respectively a first lateral end and a second lateral end with respect to an operative state or position of the electric range. Likewise a front end may denote an end that is closer to a user when operating the electric range, while a rear end may denote an end that is farther from a user when operating the electric range.

According to embodiments disclosed herein, a base plate, on which a heating unit is mounted, may be prevented from sagging in the direction of gravity. Further, according to embodiments disclosed herein, heat generated by a heating unit may be effectively delivered to a cover plate. Furthermore, according to embodiments disclosed herein, a base plate may be readily installed in a case when an electric range is assembled.

According to embodiments disclosed herein, no additional work for improving strength of a base plate is required. That is, the strength of the base plate may be improved without adding a rib, or a bead, for example.

According to embodiments disclosed herein, a plurality of base plates may completely block noise between a heating unit and electronic components below the base plates. Thus, the electronic components may be freely disposed, a size of the case may be reduced, and a space for installing an electric range may be reduced.

Embodiments are described above with reference to a number of illustrative embodiments thereof. However, the embodiments are not intended to limit the embodiments and drawings set forth herein, and numerous other modifications and embodiments can be devised by one skilled in the art without departing from the technical idea. Further, the effects and predictable effects based on configurations are to be included within the range though not explicitly described in the description of embodiments.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric range, comprising:
a case;
a cover plate coupled to the case, on which an object to be heated is placed;
a plurality of heating units accommodated in the case and disposed below the cover plate; and
a plurality of base plates disposed in the case, the plurality of heating units being provided on the plurality of base plates, wherein the plurality of base plates is disposed side by side to cover a cross-sectional area of the case; and
a reinforcement beam that connects two opposite side surfaces of the case,
wherein at least one of the plurality of base plates includes the flat plate, and wherein the plurality of bent portions comprises a first bent portion that extends from the flat plate in a vertical direction, and a second bent portion that extends from the first bent portion in a horizontal direction such that the flat plate, the first bent portion, and the second bent portion form a stepped shape or a Z shape,
wherein the reinforcement beam at least one of is disposed between first bent portions formed at neighboring edges of adjacent base plates, or supports at least one of the second bent portions formed at neighboring edges of adjacent base plates.

2. The electric range of claim 1, wherein the plurality of base plates includes a first base plate, a second base plate, and a third base plate arranged one after the other along a straight line.

3. The electric range of claim 1, wherein the second bent portion extends from the first bent portion at least one of in a direction away from the flat plate or in a direction towards an adjacent base plate.

4. The electric range of claim 1, wherein first bent portions formed at neighboring edges of adjacent base plates have surfaces that extend in parallel to each other.

5. The electric range of claim 1, wherein second bent portions formed at neighboring edges of adjacent base plates overlap one another.

6. The electric range of claim 1, wherein at least one of the first bent portion of at least one of the plurality of base plates is in surface contact with a side surface of the case or wherein the second bent portion of at least one of the plurality of base plates bears on an upper end of a side surface of the case.

7. The electric range according to claim 2, wherein a first base plate includes a first flat plate, a (1-1)th bent portion, a (1-2)th bent portion, a (1-3)th bent portion, and a (1-4)th bent portion, the (1-1)th bent portion extending at an angle from a first end of the first flat plate, and the (1-2)th bent portion extending at an angle from the (1-1)th bent portion, such that the first flat plate, the (1-1)th bent portion, and the (1-2)th bent portion form a stepped shape or a Z shape and the (1-3)th bent portion extending at an angle from a second end of the first flat plate opposite to the first end, and the (1-4)th bent portion extending at an angle from the (1-3)th bent portion, such that the first flat plate, the (1-3)th bent portion, and the (1-4)th bent portion form a stepped shape or a Z shape.

8. The electric range of claim 7, further comprising a second base plate and a third base plate disposed at opposite sides of the first base plate, wherein the second base plate includes a second flat plate, a (2-3)th bent portion, and a (2-4)th bent portion, the (2-3)th bent portion extending at an angle from a first end of the second flat plate, and the (2-4)th bent portion extending at an angle from the (2-3)th bent portion, such that the second flat plate, the (2-3)th bent portion, and the (2-4)th bent portion form a stepped shape or a Z shape, wherein the third base plate includes a third flat plate, a (3-1)th bent portion, and a (3-2)th bent portion, the (3-1)th bent portion extending at an angle from a first end of the third flat plate, and the (3-2)th bent portion extending at an angle from the (3-1)th bent portion, such that the third flat plate, the (3-1)th bent portion, and the (3-2)th bent portion form a stepped shape or a Z shape, wherein the (1-1)th bent portion and the (2-3)th bent portion are disposed in parallel, and the (1-2)th bent portion and the (2-4)th bent portion are mounted one on the other, and wherein the (1-3)th bent portion and the (3-1)th bent portion are disposed in parallel, and the (1-4)th bent portion and the (3-2)th bent portion are mounted one on the other.

9. The electric range of claim 8, wherein the second base plate further includes a (2-1)th bent portion and a (2-2)th bent portion, the (2-1)th bent portion extending at an angle from a second end of the second flat plate, and the (2-2)th bent portion extending at an angle from the (2-1)th bent portion, such that the second flat plate, the (2-1)th bent portion, and the (2-2)th bent portion form a stepped shape or a Z shape, wherein the (2-2)th bent portion is mounted onto an upper end of a side surface of the case, wherein the third base plate further includes a (3-3)th bent portion and a (3-4)th bent portion, the (3-3)th bent portion extending at an angle from a second end of the third flat plate, and the (3-4)th bent portion extending at an angle from the (3-3)th bent portion, such that the third flat plate, the (3-3)th bent portion, and the (3-4)th bent portion form a stepped shape or a Z shape, and wherein the (3-4)th bent portion is mounted onto an upper end of a side surface of the case.

10. The electric range of claim 1, further comprising:
a bracket disposed at a central portion of a lower side of the first base plate, and configured to prevent sagging of the first base plate.

11. The electric range of claim 10, further comprising:
at least one elastic element disposed on the bracket, wherein an upper end of the at least one elastic element contacts a lower surface of the first base plate to prevent sagging of the first base plate.

12. The electric range of claim 1, wherein the case includes mounting portions that extend from side surfaces of the case towards an interior thereof, and that support the base plates.
